(19) United States
(12) Patent Application Publication
(10) Pub. No.: US 2023/0305786 A1
(43) Pub. Date: Sep. 28, 2023

(54) IMAGE PROCESSING APPARATUS

(71) Applicant: KYOCERA Document Solutions Inc., Osaka-shi (JP)

(72) Inventor: Masatoshi MASUDA, Osaka-shi (JP)

(21) Appl. No.: 18/161,198

(22) Filed: Jan. 30, 2023

(30) Foreign Application Priority Data
Jan. 31, 2022 (JP) 2022-012556

(51) Int. Cl. H04N 1/387

(52) U.S. Cl. CPC H04N 1/3875; H04N 2201/218

(57) ABSTRACT

A save control unit stores document data and manager data associated with each other. A request acquiring unit acquires an output request including: requester data, document designation data, and allowable display time data. An output control unit, when the output request is acquired, and on a condition of fulfilling a user condition and a time condition, executes a document image output process according to receiving of a request from the image display apparatus. The user condition is a condition that the manager data is consistent with the requester data. The time condition is a condition that an elapsed time from a time point when the output request was acquired is within a time shown by the allowable display time data. The document image output process is a process of sending, to the image display apparatus, an output image that is based on the target document data.

### INCORPORATION BY REFERENCE

This application is based upon, and claims the benefit of priority from, corresponding Japanese Patent Application No. 2022-012556 filed in the Japan Patent Office on Jan. 31, 2022, the entire contents of which are incorporated herein by reference.

### BACKGROUND

### Field of the Invention

This disclosure relates to an image processing apparatus capable of wirelessly communicating with a host apparatus and an image display apparatus.

### Description of Related Art

Image processing apparatuses such as printer, copier, facsimile apparatus or multifunction peripheral are often shared by a plurality of users. For example, the image processing apparatus, as the case may be, is shared by a relatively small workplace or a household.

Further, there is known a system in which a home server, a home appliance, and a computer terminal can communicate with each other by a home network. The home server can send image data to the computer terminal. The computer terminal is capable of displaying an image that is based on the image data.

### SUMMARY

An image processing apparatus according to an aspect of this disclosure is capable of wirelessly communicating with a host apparatus and an image display apparatus. The image processing apparatus includes: a save control unit; a request acquiring unit; and an output control unit. The save control unit stores, in a nonvolatile storage apparatus, document data and manager data associated with each other, wherein the manager data identifies a manager, among plural users, who manages the document data. The request acquiring unit acquires an output request including: requester data that identifies a requester who is any of the plural users, document designation data that designates the document data, and allowable display time data that shows a time. The output control unit, when the output request is acquired, and on a condition of fulfilling a user condition and a time condition, executes a document image output process according to receiving of a request from the image display apparatus. The user condition is a condition that the manager data associated with target document data which is the document data designated by the document designation data is consistent with the requester data. The time condition is a condition that an elapsed time from a time point when the output request was acquired is within a time shown by the allowable display time data. The document image output process is a process of sending, to the image display apparatus, an output image that is based on the target document data.

### BRIEF DESCRIPTION OF THE DRAWINGS

FIG. 1 is a block diagram showing a configuration of an image output system including an image processing apparatus according to an embodiment.

FIG. 2 is a block diagram showing a configuration of a host apparatus.

FIG. 3 is a block diagram showing a configuration of an image display apparatus.

FIG. 4 is a flowchart showing an example of a procedure of a document management process in the image processing apparatus according to the embodiment.

FIG. 5 is a flowchart showing an example of a procedure of a document save process in the image processing apparatus according to the embodiment.

FIG. 6 is a flowchart showing an example of a procedure of a document image output control in the image processing apparatus according to the embodiment.

FIG. 7 is a diagram showing an example of document management data in the image processing apparatus according to the embodiment.

FIG. 8 is a diagram showing an example of a configuration of document save request data in the image processing apparatus of the embodiment.

FIG. 9 is a diagram showing an example of a configuration of image output request data in the image processing apparatus according to the embodiment.

### DETAILED DESCRIPTION

A description will hereinafter be made on an embodiment of this disclosure with reference to the drawings. It should be noted that the following embodiment is an example embodying this disclosure, and does not limit the technical scope of this disclosure.

An image processing apparatus 10 according to the embodiment is an apparatus capable of executing an image process such as a printing process or an image reading process. The printing process is a process of forming an image on a sheet 91. The image reading process is a process of reading the image from a document 92.

The image processing apparatus 10 can wirelessly communicate with a host apparatus 8 and an image display apparatus 7. The image processing apparatus 10 can communicate with the host apparatus 8 and the image display apparatus 7 through a wireless LAN (Local Area Network) 80.

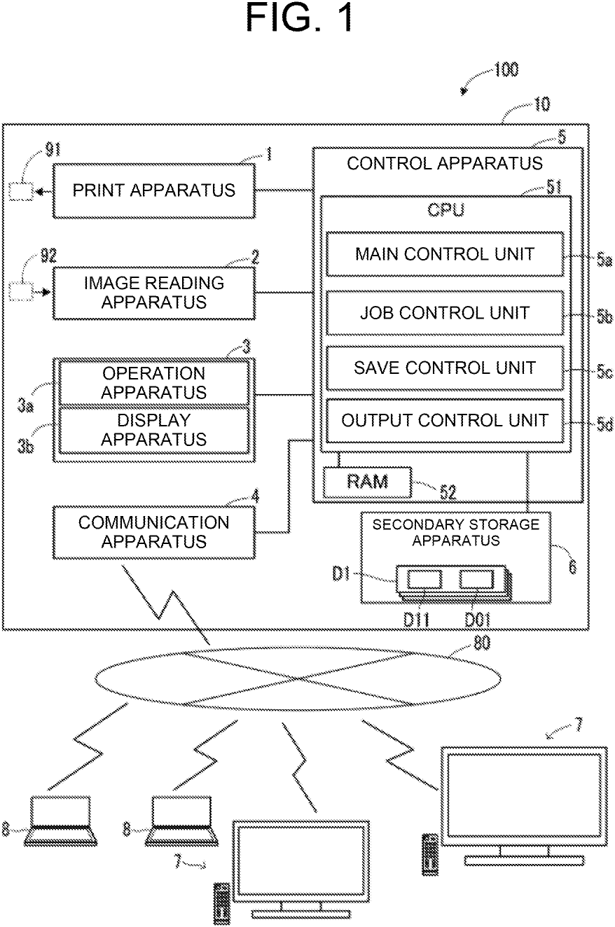

The image processing apparatus 10, together with the host apparatus 8 and the image display apparatus 7, constitutes an image output system 100 (see FIG. 1).

For example, the image processing apparatuses 10 are a copier, a facsimile apparatus, or a multifunction peripheral. The multifunction peripheral has functions of the copier and of facsimile apparatus.

The host apparatus 8 can communicate with the image processing apparatus 10. For example, the host apparatus 8 generates document data D01, and sends a print request, together with the document data D01, to the image processing apparatus 10 (see FIG. 1).

The image display apparatus 7 can communicate with the image processing apparatus 10. For example, the image display apparatus 7 is a television apparatus.

### Configuration of Image Processing Apparatus

As shown in FIG. 1, the image processing apparatus 10 is equipped with a print apparatus 1, an image reading apparatus 2, a user interface apparatus 3, a communication apparatus 4, a control apparatus 5, a secondary storage apparatus 6, and the like.

The print apparatus 1 executes the above printing process by using a specific method such as an electrophotographic method or an inkjet printing method. The print apparatus 1 is equipped with a sheet transport unit that transports the sheet 91, and a print unit that forms an image on the sheet 91.

The image reading apparatus 2 executes the above image reading process. The image reading apparatus 2 is equipped with an optical scanning unit that scans light onto the document 92, and an image sensor that receives reflected light reflected on the document 92.

The user interface apparatus 3 includes an operation apparatus 3a and a display apparatus 3b. The operation apparatus 3a is an apparatus that accepts a human operation. For example, the operation apparatus 3a includes an operation button and a touch screen. The display apparatus 3b can display information. For example, the display apparatus 3b includes a display panel such as a liquid crystal panel.

The communication apparatus 4 is a communication interface which executes a communication with an external apparatus, such as the host apparatus 8, through the network 80. Through the communication apparatus 4, the control apparatus 5 executes all of data sending and receiving operations to and from the above other apparatuses.

In the following description, the image read from the document 92 by the above image reading process of the image reading apparatus 2 is referred to as a read image.

The print apparatus 1 is capable of executing the printing process based on the read image’s data or based on the print request received from the host apparatus 8 through the communication apparatus 4. The above read image’s data is an example of the document data D01.

Also, the communication apparatus 4 is capable of executing an image data sending process that sends the read image’s data through the network 80 to a designated destination.

The control apparatus 5 executes various calculations, a data process, and a control of various electronic apparatuses provided for the image processing apparatus 10. The control apparatus 5 includes a CPU 51, a RAM (Random Access Memory) 52, and the like.

The secondary storage apparatus 6 is a computer-readable nonvolatile storage apparatus. The secondary storage apparatus 6 can store a computer program and various data. For example, one or both of a hard disk drive and an SSD (solid state drive) are employed as the secondary storage apparatuses 6.

The secondary storage apparatus 6 stores the computer program executed by the CPU 51, and the data referenced by the CPU 51. The CPU 51 is an example of a processor.

The CPU 51 is the processor that executes the above computer program, which is stored in the secondary storage apparatus 6, thereby to execute various data processes and controls.

Also, it is conceivable that, in place of the CPU 51, any other processor such as a digital signal processor (DSP) can execute the above data processes and controls.

The RAM 52 is a computer-readable nonvolatile storage apparatus. The RAM 52 primarily stores the computer program executed by the CPU 51, and the data that is output and referenced by the CPU 51 in the process of executing the computer program.

The CPU 51 includes a plurality of processing modules realized by executing the computer program. The plural processing modules in CPU 51 include a main control unit 5a, a job control unit 5b, a save control unit 5c, an output control unit 5d, and the like.

The main control unit 5a mainly monitors an operation for the operation apparatus 3a, and data sending/receiving by the communication apparatus 4. Further, when detecting the operation for the operation apparatus 3a or the data sending/receiving, the main control unit 5a controls the start of process that accords to the detected contents.

The job control unit 5b controls the print apparatus 1, the image reading apparatus 2, and the communication apparatus 4. The job control unit 5b causes part or all of the print apparatus 1, the image reading apparatus 2, and the communication apparatus 4 to execute the above requested image processes.

The print apparatus 1, the image reading apparatus 2, and the communication apparatus 4 are each an example of the image process unit capable of executing the above image process. In this embodiment, the image processes include the printing process, the image reading process, and the image data sending process.

The save control unit 5c executes a process related to the document data D01′s saving in the secondary storage apparatus 6. For example, in the secondary storage apparatus 6, the save control unit 5c stores the read image’s data as the document data D01.

Also, the save control unit 5c acquires the document data D01 from the host apparatus 8 through the network 80, and stores the acquired document data D01 in the secondary storage apparatus 6.

The output control unit 5d executes the process of sending, to the image display apparatus 7, the data of the image that is based on the document data D01 stored in the secondary storage apparatus 6.

The image processing apparatus 10, as the case may be, is shared by a plurality of users. For example, the image processing apparatus 10, as the case may be, is shared by a relatively small workplace or a household.

### Configuration of Host Apparatus 8

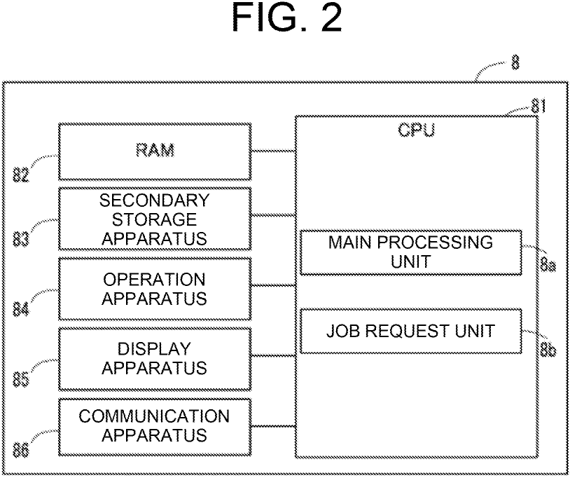

As shown in FIG. 2, the host apparatus 8 includes a CPU 81, a RAM 82, a secondary storage apparatus 83, an operation apparatus 84, a display apparatus 85, and a communication apparatus 86.

The operation apparatus 84 is an apparatus that accepts a human operation. For example, the operation apparatus 84 includes a keyboard, a mouse, and the like. Also, the operation apparatus 84, as the case may be, includes a touch screen. The display apparatus 85 can show information. For example, the display apparatus 85 includes a display panel such as a liquid crystal panel.

The communication apparatus 86 is a communication interface which executes which executes a communication with an external apparatus, such as the image processing apparatus 10, through the network 80. Through the communication apparatus 86, the CPU 81 executes all of data sending and receiving operations of data to and from other apparatuses.

The secondary storage apparatus 83 is a computer-readable nonvolatile storage apparatus. The secondary storage apparatus 83 can store a computer program and various data. For example, one or both of a hard disk drive and an SSD (solid state drive) are employed as the secondary storage apparatuses 83.

The secondary storage apparatus 83 stores the computer program executed by CPU 81, and the data referenced by the CPU 81.

The CPU 81 is a processor that executes the above computer program, which is stored in the secondary storage apparatus 83, thereby to execute various data processes and controls. The CPU 81 is an example of a processor.

The RAM 82 is a computer-readable nonvolatile storage apparatus. The RAM 82 primarily stores the computer program executed by the CPU 81, and the data that is output and referenced by the CPU 81 in the process of executing the computer program.

The CPU 81 includes a plurality of processing modules realized by executing the computer program. The plural processing modules in the CPU 81 include a main processing unit 8a, a job request unit 8b, and the like.

The main processing unit 8a executes a control to start various processes according to an operation for the operation apparatus 84, a control of the display apparatus 85, and the like.

The job request unit 8b executes the process of requesting the image processing apparatus 10 for the image process. Through the communication apparatus 86 to the image processing apparatus 10, the Job request unit 8b sends data showing the above image process request.

### Configuration of Image Display Apparatus 7

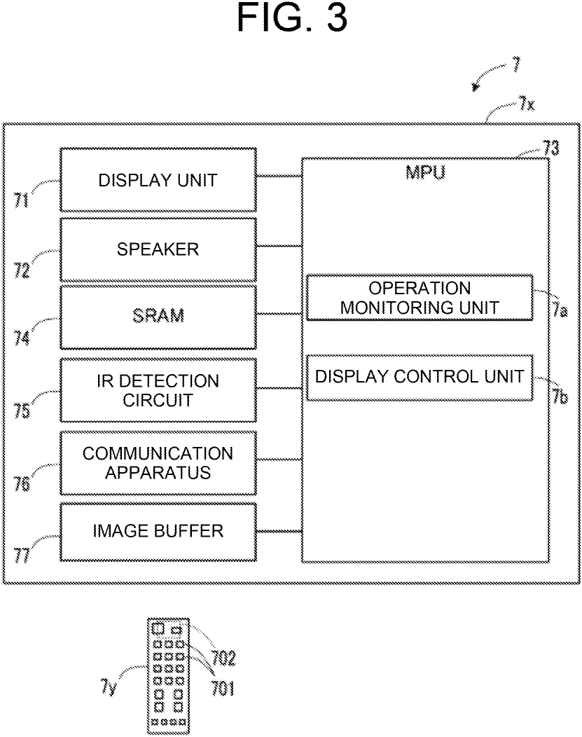

As shown in FIG. 3, the image display apparatus 7 has a main body 7x and a remote controller 7y. The main body 7x includes a display unit 71, a speaker 72, an MPU (Micro Processing Unit) 73, an SRAM (Static Random Access Memory) 74, an IR detection circuit 75, a communication apparatus 76, an image buffer 77, and the like.

The remote controller 7y is equipped with a plurality of operation buttons 701 and an infrared output circuit 702. The plural operation buttons 701 include a power button, plural number buttons, a volume up button, a volume down button, a channel up button, a channel down button, an input switch button, and the like.

When any of the plural operation buttons 701 is operated; to the main body 7x, the infrared output circuit 702 sends, as an infrared signal, an operation command that corresponds to the content of the operation.

The display unit 71 is an apparatus that displays the image. The speaker 72 outputs a sound that is synchronized with the image displayed on the display unit 71.

The IR detection circuit 75 receives the infrared signal sent from the remote controller 7y, and sends, to the MPU 73, the operation command shown by the infrared signal.

The MPU 73 executes the computer program stored in the SRAM 74, thereby to execute the process that corresponds to the above operation command.

The communication apparatus 76 is a communication interface which executes, through the network 80, a communication with an external apparatus such as the image processing apparatus 10. The image buffer 77 temporarily stores data of an image displayed on the display unit 71.

The MPU 73 includes a plurality of processing modules realized by executing the computer program. The plural processing modules in the MPU 73 include an operation monitoring unit 7a, a display control unit 7b, and the like.

When the infrared signal is detected by the IR detection circuit 75, the operation monitoring unit 7a causes the display control unit 7b to execute a process that corresponds to the operation command.

The display control unit 7b causes the image buffer 77 to store the data of the image that accords to the above operation command, and causes the display unit 71 to display an image that is based on the data stored in the image buffer 77.

Also, the image display apparatus 7 is equipped with other apparatuses necessary to operate as a television receiver, such as a signal input circuit and a tuner. The above signal input circuit is a circuit to which a broadcast signal is input. The above tuner is a circuit that extracts video and audio signals from the broadcast signal.

The display control unit 7b causes the display unit 71 to display an image that is based on the video signal extracted by the above tuner. Further, an acoustic signal extracted by the tuner is sent to the speaker 72.

By the way, when the image processing apparatus 10 is shared at the household or in the small workplace, the image processing apparatus 10 is a small machine that can print on a sheet 91 up to about A4 size (length: 297 mm, width: 210 mm), for example.

The size of the original image that is based on the document data D01, as the case may be, is larger than the size that can be printed by the image processing apparatus 10. In this case, it is desirable that the original image, in its original or enlarged size, can be displayed on the display unit 71 of the image display apparatus 7. This allows the user to check the original image in a larger size without consuming the sheet 91.

For example, the television apparatus is a relatively large and widely used image display apparatus 7. Thus, it is desirable that the original image, in its original or enlarged size, can be displayed on the television apparatus.

For example, the document data D01 is generated by host apparatus 8 which can communicate with the image processing apparatus 10. In this case, the document data D01 is sent from the host apparatus 8 to the image processing apparatus 10. The host apparatus 8 is an information processing apparatus such as a personal computer, a tablet computer, or the like.

When the image processing apparatus 10 is equipped with the image reading apparatus 2, the data of the read image, as the case may be, is generated as document data D01.

It is conceivable that the image processing apparatus 10 is equipped with a function to send, according to a request from the image display apparatus 7, to the image display apparatus 7, an image that is based on the document data D01. In this case, the user operates the remote controller 7y of the image display apparatus 7, for example, thereby to make it possible to check, by the display unit 71 of the image display apparatus 7, the data that is based the document data D01.

However, when the document data D01 is stored in the secondary storage apparatus 6 of the image processing apparatus 10 which is shared by plural users, there is a risk that information in the document data D01 may be leaked to a user other than the user who manages the document data D01.

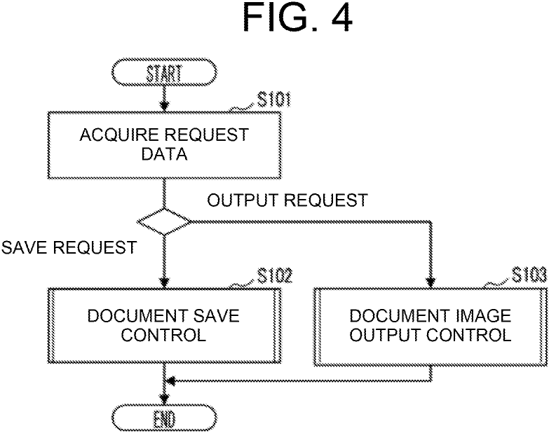

In the image processing apparatus 10, the main control unit 5a, the save control unit 5c, and the output control unit 5d execute a document management process to be described below (see FIG. 4). This allows the image processing apparatus 10, while avoiding information leak of document data D01, to display the image, which is based on the document data D01, according to the request from the image display apparatus 7.

### Document Management Process

In the following, an example of a procedure of the document management process is described with reference to a flowchart shown in FIG. 4.

When receiving, through the operation apparatus 3a or the communication apparatus 4, a request for the process on the document data D01, the main control unit 5a starts the above document management process.

In the description below, S101, S102, ··· show identification signs of plural steps in the document management process. The main control unit 5a, in the above document management process, first executes a process in step S101.

### <Step S101>

In step S101, the main control unit 5a acquires request data that shows a request for the process on the document data D01.

For example, in step S101, the main control unit 5a acquires the request data from the host apparatus 8 through the network 80. Also, in step S101, the main control unit 5a acquires, as the above request data, the data input through the operation apparatus 3a.

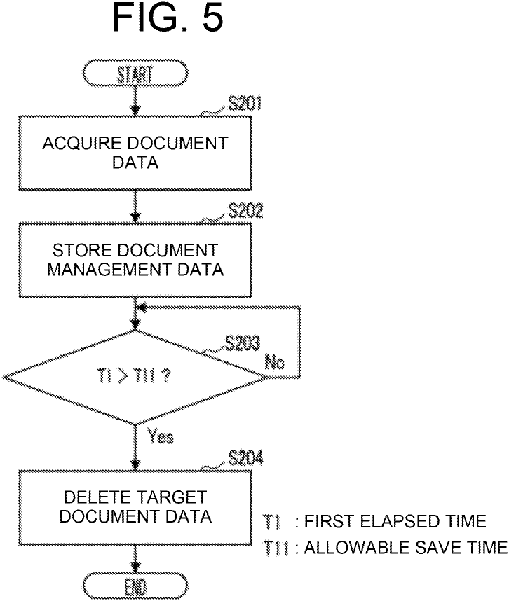

When the main control unit 5a has acquired save request data D2 as the request data, the save control unit 5c executes a process in step S102 (see FIGS. 5 and 8). The save request data D2 shows a request for a process to save the document data D01 in the secondary storage apparatus 83.

The save request data D2 includes acquiring method data D21, allowable save time data D22, and a user code D10 (see FIG. 8). The acquiring method data D21 shows the acquiring method of the document data D01 to be saved.

In this embodiment, the acquiring method data D21 is data that shows the receiving or reading process. The above receiving process shows receiving the document data D01 from the host apparatus 8. The reading process shows acquiring, as the document data D01, the data of the read image acquired by the image reading process of the image reading apparatus 2.

The allowable save time data D22 shows the time allowed for the document data D01 to be stored in the secondary storage apparatus 83.

The user code D10 is data that identifies the user. For example, the user code D10 includes one or both of a user ID and a password.

When the host apparatus 8 is an apparatus intended to be used by only one user, the user code D10 may be data that identifies the host apparatus 8.

The user code D10 included in the save request data D2 is data that identifies the document data D01 to be saved. The manager is any of the plural users.

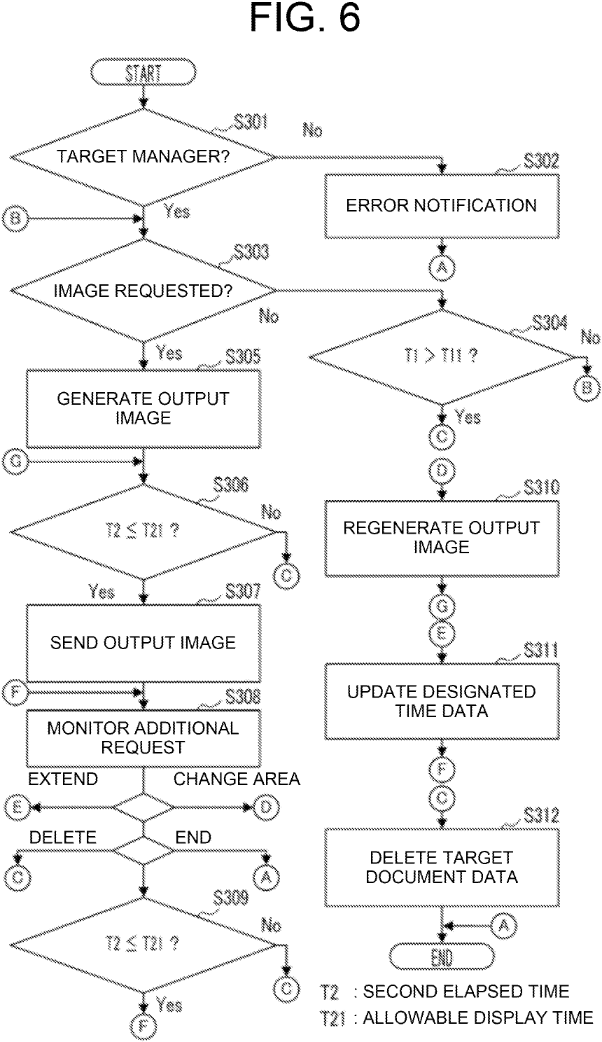

Meanwhile, when the main control unit 5a has acquired output request data D3 as the request data, the output control unit 5d executes a process in step S103 (see FIGS. 6 and 9). The output request data D3 shows a request for a process to send, to the image display apparatus 7, an image that is based on the document data D01 stored in the secondary storage apparatus 83.

The output request data D3 includes document designation data D31, output destination data D32, allowable display time data D33, and a user code D10 (see FIG. 9).

The document designation data D31 shows information that designates one of the document data D01 stored in the secondary storage apparatus 83.

For example, the main control unit 5a presents, as options, names of all the document data D01 stored in the secondary storage apparatus 83, and acquires, as the document designation data D31, data that designates one of the options.

The above options are sent through the network 80 to the host apparatus 8, thereby to be presented through the display apparatus 85 of the host apparatus 8. Or, the above options are presented through the display apparatus 3b of the image processing apparatus 10.

When the image processing apparatus 10 can communicate with the plural image display apparatuses 7, the output destination data D32 is data that identifies one of the plural image display apparatuses 7. When the image processing apparatus 10 can communicate with only one image display apparatus 7, the main control unit 5a may set the output destination data D32.

The allowable display time data D33 shows the time allowed for displaying the image that is based on the document data D01.

The user code D10 included in the output request data D3 is data that identifies a requester who requests for displaying the image that is based on the document data D01. The above requester is any of the plural users. The user code D10 included in the output request data D3 is an example of the requester data that identifies the requester.

The main control unit 5a that executes the process in step S101 is an example of a request acquiring unit that acquires an output request. The output request data D3 is data that corresponds to the above output request.

### <Step S102>

In step S102, the save control unit 5c executes a document save control. A specific example of the above document save control is to be described below (see FIG. 5). The save control unit 5c, after executing the document save control, ends the document management process.

### <Step S103>

In step S103, the output control unit 5d executes a document image output control. A specific example of the above document image output control is to be described below (see FIG. 6). The output control unit 5d, after executing the document image output control, ends the document management process.

### Document Save Control

In the following, an example of a procedure of the document save process is described with reference to a flowchart shown in FIG. 5.

In the following description, S201, S202, ... show identification signs of plural steps in the document save control.

The save control unit 5c, in the above document save control, first executes the process of step S201.

### <Step S201>

In step S201, the save control unit 5c acquires the document data D01 by a method shown by the acquiring method data D21 of the save request data D2.

Specifically, when the acquiring method data D21 is data that shows the above receiving process, the save control unit 5c acquires the document data D01 from the host apparatus 8 through the network 80.

Meanwhile, when the acquiring method data D21 is data showing the above reading process, the job control unit 5b operates the image reading apparatus 2, and the save control unit 5c acquires, as the document data D01, the data of the read image.

The save control unit 5c, after acquiring the document data D01, executes the process in step S202.

### <Step S202>

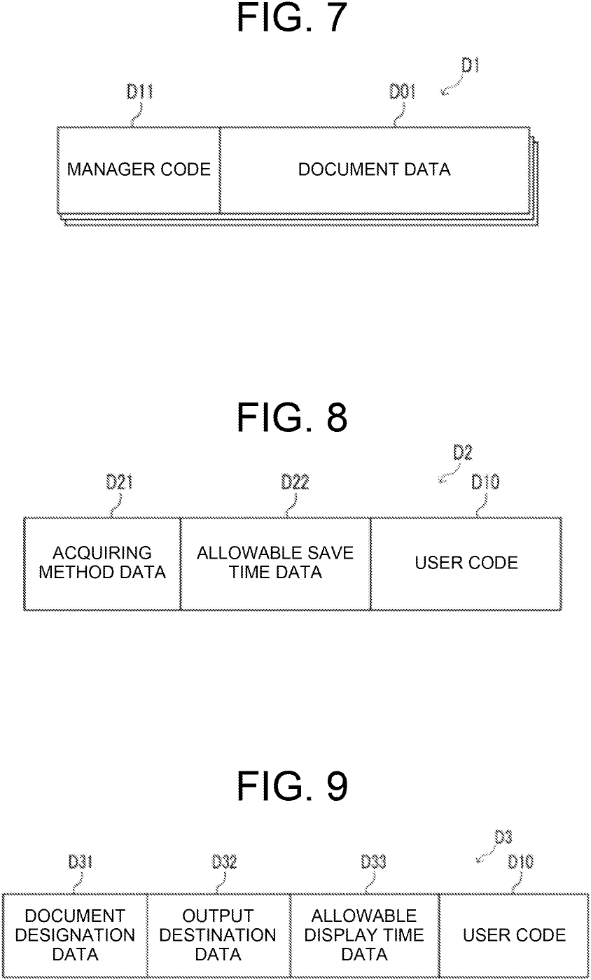

In step S202, the save control unit 5c stores, in the secondary storage apparatus 83, the document management data D1 including the document data D01 and a manager code D11 (see FIGS. 1 and 7). In the document management data D1, the document data D01 is associated with the manager code D11.

The manager code D11 is the user code D10 included in the save request data D2. The manager code D11 is an example of the manager data that identifies the manager.

That is, in step S202, the save control unit 5c, in the secondary storage apparatus 83, stores the document data D01 and the manager code D11 associated with each other.

After executing the process in step S202, the save control unit 5c executes the process in step S203.

### <Step S203>

In step S203, the save control unit 5c counts a first elapsed time T1 until a first elapsed time T1 exceeds the allowable save time T11.

The first elapsed time T1 is an elapsed time from a time point when the document data D01 was stored in the secondary storage apparatus 83. The allowable save time T11 is time shown by the allowable save time data D22 included in the save request data D2.

When the first elapsed time T1 exceeds the allowable save time T11, the save control unit 5c executes the process in step S204.

### <Step S204>

In step S204, the save control unit 5c deletes the document data D01 in the secondary storage apparatus 83.

The document data D01 to be deleted in step S204 is data for which the allowable save time T11 has elapsed from the time point when the data was stored in the secondary storage apparatus 83.

The save control unit 5c, after executing the process in step S204, ends the document save control.

Executing the processes of steps S203 and S204 reduces the risk of information leak due to the document data D01 stored in the secondary storage apparatus 83 for a long time period.

Further, in the save request data D2, the allowable save time data D22 may be omitted. When the allowable save time data D22 is omitted, processes in step S203 and step S204 are skipped.

### Document Image Output Control

Next, an example of a procedure of the document image output control is described with reference to a flowchart shown in FIG. 6.

In the following description, S301, S302, ... show identification signs of plural steps in the document image output control. The output control unit 5d, in the above document image output control, first executes a process in step S301.

In the following description, the user code D10 included in the output request data D3 is referred to as a requester code.

Also, the document data D01 designated by the document designation data D31 included in the output request data D3 is referred to as target document data.

Also, the image display apparatus 7 identified by the output destination data D32 included in the output request data D3 is referred to as a target display apparatus.

Also, the manager code D11 associated with the above target document data in the document management data D1 is referred to as a target manager code. Also, the manager corresponding to the target manager code is referred to as a target manager.

### <Step S301>

In step S301, the output control unit 5d compares the requester code with the target manager code, thereby to determine whether or not the requester is the target manager.

The output control unit 5d when the target manager code is consistent with the requester code, determines that the requester is the target manager. The condition that the target manager code is consistent with the requester code is an example of a user condition.

The output control unit 5d, when determining that the requester is the target manager, executes the process in step S303. Meanwhile, the output control unit 5d, when determining that the requester is not the target manager, executes the process in step S302.

### <Step S302>

In step S302, the output control unit 5d outputs an error notification showing that the requester is not the target manager.

For example, an output of the error notification is sending an error message to the host apparatus 8. Or, the output of the error notification is outputting error message to the display apparatus 3b of the image processing apparatus 10.

The output control unit 5d, after executing the process in step S302, ends the above document image output control.

### <Step S303>

In step S303, the output control unit 5d monitors whether or not the image request is received from the target display apparatus.

In the image display apparatus 7, the operation monitoring unit 7a, when detecting a specific image request operation for the remote controller 7y, sends the image request through the network 80 to the image processing apparatus 10.

For example, the image request operation is a long-pressing operation for the input switch button of the remote controller 7y.

The output control unit 5d, when the image request is received from the target display apparatus, executes the process in step S305.

Meanwhile, the output control unit 5d, when the image request is not received from the target display apparatus, executes the process in step S304.

### <Step S304>

In step S304, the output control unit 5d compares the first elapsed time T1 with the allowable save time T11.

The output control unit 5d, when the first elapsed time T1 exceeds the allowable save time T11, executes the process in step S312.

Meanwhile, the output control unit 5d, when the first elapsed time T1 does not exceed the allowable save time T11, moves the process to step S303.

Further, in the save request data D2, the allowable save time data D22, as the case may be, is omitted. In this case, a preset maximum allowable time is compared with the first elapsed time T1 instead of the allowable save time T11.

### <Step S305>

In step S305, the output control unit 5d generates data of the output image that is based on the target document data.

The output control unit 5d can generate, as the data of the output image, data of an image of an area of a part of all document images that are based on the target document data.

For example, the data of the output image generated in step S305 is data of a first page image in the target document data.

The output control unit 5D, after executing the process in step S305, executes the process in step S306.

### <Step S306>

In step S306, the output control unit 5d compares a second elapsed time T2 with an allowable display time T21.

The second elapsed time T2 is an elapsed time from a time point when the output request data D3 was acquired. The allowable display time T21 is a time shown by the allowable display time data D33 included in output request data D3.

The output control unit 5d, when the second elapsed time T2 is within the allowable display time T21, executes the process in step S307. Meanwhile, the output control unit 5d, when the second elapsed time T2 exceeds the allowable display time T21, executes the process in step S312.

### <Step S307>

In step S307, the output control unit 5d sends the data of the output image to the target display apparatus.

When the process in step S307 is executed, the display control unit 7b of the target display unit receives the data of the output image. Further, the display control unit 7b stores the data of the output image in the image buffer 77, and causes the display unit 71 to display the output image.

The output control unit 5D, after executing the process in step S307, executes the process in step S308.

### <Step S308>

In step S308, the output control unit 5d monitors whether or not an additional request other than the image request is received from the target display apparatus.

In the image display apparatus 7, the operation monitoring unit 7a, when detecting a specific additional request operation for the remote controller 7y, sends the additional request through the network 80 to the image processing apparatus 10.

For example, the additional request is an area change request, an extension request, a deletion request, or an end request.

The area change request shows a request to change the area of the output image in all document images that are based on the target document data. For example, the area change request includes one or more of a scroll up request, a scroll down request, an image enlargement request, and an image reduction request.

Each of the above scroll up and scroll down requests is an example of a request to scroll the image.

The above extension request shows a request to update the allowable display time data D33 in a manner to extend the allowable display time T21.

The deletion request shows a request to delete the target document data in the secondary storage apparatus 83. The end request shows a request to end the display of the output image.

In the image display apparatus 7, the operation monitoring unit 7a, when detecting an additional request operation for the remote controller 7y, sends the additional request, which corresponds to the additional request, to the image processing apparatus 10.

For example, the additional request operation includes operations for the channel up button, the channel down button, the volume up button or the volume down button. Also, the operation for a numeric keypad may be employed as an operation to designate the extension time in the extension request.

The output control unit 5d, when the additional request is not received from the target display apparatus, executes the process in step S309.

The output control unit 5d, when the area change request is received from the target display apparatus, executes the process in step S310.

The output control unit 5d, when the extension request is received from the target display apparatus, executes the process in step S311.

The output control unit 5d, when the deletion request is received from the target display apparatus, executes the process in step S312.

The output control unit 5D, when the end request is received from the target display apparatus, ends the document image output control.

Further, the end request may also serve as the deletion request. In this case, the output control unit 5d, when the end request is received from the target display apparatus, executes the process in step S310.

### <Step S309>

In step S309, the output control unit 5d compares the second elapsed time T2 with the allowable display time T21.

The output control unit 5d, when the second elapsed time T2 is within the allowable display time T21, moves the process to step S308. Meanwhile, the output control unit 5d, when the second elapsed time T2 exceeds the allowable display time T21, executes the process in step S312.

### <Step S310>

In step S310, the output control unit 5d regenerates, as the data of the output image, data of the image of a new area that accords to the above area change request.

The output control unit 5D, after executing the process in step S310, moves the process to step S306.

### <Step S311>

In step S311, the output control unit 5d, according to the extension request, updates the allowable display time data D33, which corresponds to the target document data, to data showing a longer time.

The output control unit 5d, after executing the process in step S311, moves the process to step S308.

### <Step S312>

In step S312, the output control unit 5d deletes the target document data in the secondary storage apparatus 83.

After executing the process in step S312, the output control unit 5d ends the above document image output control.

As shown above, the output control unit 5d, when output request data D3 is acquired, executes the above document image output control (steps S301 to S312).

Also, the output control unit 5d, on a condition of fulfillment of the condition in step S301 and fulfillment of the condition in step S306, executes the process in step S307 according to receiving of the request from the target display apparatus.

The condition in step S301 is an example of the user condition that the target manager code is consistent with the requester code. The condition in step S306 is an example of the time condition that the second elapsed time T2 is within the allowable display time T21.

The process in step S307 is the process of sending, to the image display apparatus 7, the output image that is based on the target document data. The process in step S307 is an example of the document image output process.

When the second elapsed time T2 exceeds the allowable display time T21, the target document data is deleted from the secondary storage apparatus 83 (see step S306, step S309, and step S312). This reduces the risk of information leak due to the document data D01 stored in the secondary storage apparatus 83 for a long time period.

Also, the target document data is deleted from the secondary storage apparatus 83 according to the deletion request (see step S308 and step S312). This also allows for the deleting of the target document data by the operation of the remote controller 7y.

When receiving the area change request from the target display apparatus, the output control unit 5d, in step S307, sends, as a new output image, the image of the area that corresponds to the area change request, to the target display apparatus (see steps S308, S310, S306, S307).

The new the output image is an image which is among all document images that are based on the target document data, and which is of an area that accords to the area change request.

Executing the process that accords to the above area change request makes it possible that operating the remote controller 7y can change the display state of the image on the target display apparatus by.

The images of two documents, as the case may be, are simultaneously displayed on the display apparatus 3b of the host apparatus 8 and on the display unit 71 of the image display apparatus 7, respectively. In this case, operating the operation apparatus 3a of the host apparatus 8 and the remote controller 7y in parallel can change display states of the images of the two documents. Thus, the operation of moving a cursor between the two screens of the host apparatus 8 and image display apparatus 7 is unnecessary.

What is claimed is:

1. An image processing apparatus capable of wirelessly communicating with a host apparatus and an image display apparatus, the image processing apparatus comprising:
a save control unit that stores, in a nonvolatile storage apparatus, document data and manager data associated with each other, wherein the manager data identifies a manager, among plural users, who manages the document data;
a request acquiring unit that acquires an output request including:
requester data that identifies a requester who is any of the plural users,
document designation data that designates the document data, and
allowable display time data that shows a time; and
an output control unit that, when the output request is acquired, and on a condition of fulfilling a user condition and a time condition, executes a document image output process according to receiving of a request from the image display apparatus, wherein
the user condition is a condition that the manager data associated with target document data which is the document data designated by the document designation data is consistent with the requester data,
the time condition is a condition that an elapsed time from a time point when the output request was acquired is within a time shown by the allowable display time data, and
the document image output process is a process of sending, to the image display apparatus, an output image that is based on the target document data.

2. The image processing apparatus according to claim 1, wherein
in the document image output process, the output control unit is capable of sending, as the output image, an image of an area of a part of all document images that are based on the target document data, to the image display apparatus, and
further, when having received an area change request from the image display apparatus, the output control unit, in the document image output process, sends, as a new output image, an image which is among the all document images and which is of an area that corresponds to the area change request, to the image display apparatus.

3. The image processing apparatus according to claim 2, wherein
the area change request includes one or more of a request to scroll an image, a request to enlarge the image, and a request to shrink the image.

4. The image processing apparatus according to claim 1, wherein
when the elapsed time from the time point when the output request was acquired exceeds the time shown by the allowable display time data, the output control unit deletes the target document data from the storage apparatus.

5. The image processing apparatus according to claim 1, wherein
the output control unit, when having received an extension request from the image display apparatus, updates the allowable display time data to data showing a longer time.

6. The image processing apparatus according to claim 1, wherein
the output control unit, when having received a deletion request from the image display apparatus, deletes the target document data from the storage apparatus.
